(19) United States
(12) Patent Application Publication
(10) Pub. No.: US 2007/0124867 A1
(43) Pub. Date: Jun. 7, 2007

(54) DUCT ASSEMBLY TOOL

(76) Inventors: Anthony Todd Woods, Longmont, CO (US); Michael J. Barrowman, Thornton, CO (US)

Correspondence Address: GLENN L. WEBB, P.O BOX 951, CONIFER, CO, 80433, US

(21) Appl. No.: 11/164,815

(22) Filed: Dec. 6, 2005

(51) Int. Cl. B25F 1/00

(52) U.S. Cl. 7/164

(57) ABSTRACT

A combination tool for the assembly of sheet metal ductwork. The tool provides a cleat engaging aperture for closing the gap between adjoining ductwork. The tool also includes a jaw for engaging the edges of sheet metal pieces for creating a fold and for creating a continuous seam. The tool also includes a measurement ruler, scribe holes and leveling bubbles for the assembly of ductwork.

### FIELD OF THE INVENTION

The present invention is directed to the field of heating, ventilation and air conditioning and particularly to a duct assembly tool for drawing and pinching two pieces of duct work together.

### BACKGROUND OF THE INVENTION

Generally in the heating and cooling field, ductwork is used to convey heated and cooled air. The ductwork is normally hung from the building's ceiling or rafters. Generally, the ducts have a circular or rectangular shape, are fabricated from sheet metal material, and range in length from eight to twelve feet long. Particularly in rectangular shaped ductwork, the ducts have assembly flanges on each end to enable a cleat to be positioned over the flanges to secure the ducts to one another.

Generally when duct work is hung overhead, a gap is created between two adjacent ducts necessitating drawing the ducts together in order that a cleat may be positioned over the flanges to secure the ducts together. Different types of tools are used to draw duct assembly flanges together in order to enable a cleat to be positioned onto the adjacent duct flanges. Currently available tools for securing ductwork and the like together vary in their design and methods and are often referred to as “duct pullers” or “duct stretchers”. Methods utilized by these tools include pulling or stretching ductwork with a rigid or offset bar with attached gripper wheels or by utilizing a clamping or squeezing device similar to a pair of pliers or other vise-grips.

These tools have several disadvantages. One disadvantage is that the present tools can be heavy and are often quite large, in some cases upwards of 21″ long, making them not easily accessible, as they typically can't be carried in a tool pouch. Rather they are generally stored in a toolbox or a work vehicle making them less than convenient when not carried with other everyday heating, ventilation and air conditioning (“HVAC”) tools within the tool pouch. Another disadvantage is they are often rigid and require exertion of large amounts of force to draw adjacent duct flanges together to enable a cleat to be positioned over the flanges. Still another disadvantage is their cost. Many of these tools range in price from twenty-four dollars to upwards of forty-five dollars. Yet another disadvantage is the limits these tools have in closely spaced ductwork environments. Those tools that utilize the pulling, stretching, or clamping methods are generally not well-suited for working with closely spaced ductwork because the design and size can often limit accessibility, especially when drawing ductwork run closely parallel to each other.

The present invention solves these problems by providing a unique heating and cooling ductwork assembly tool.

### SUMMARY OF THE INVENTION

The present invention solves these and other problems by providing a unique tool for assembly heating and cooling ductwork. The tool of the present invention provides a combination of features that assist in the assembly process. The tool can include one or all of these features.

The tool in one preferred embodiment of the present invention includes a cleat engaging aperture on one end of the tool. This cleat engaging aperture is formed in a substantially V shape to engage the cleats of adjacent ductwork. The tool is forced downward to force the cleats together. A channel that extends inward from the V aperture forces the cleats against one another so the adjacent ductwork can be secured together.

In a preferred embodiment, the tool also includes a jaw that extends along the length of the tool. The jaw includes a slot that can be inserted over the edge of the sheet metal. The tool is then rotated to create a fold. The slot can also be inserted over the edges of pieces of sheet meal to create a seam.

Another preferred embodiment of the present invention provides a measurement ruler on the tool. The ruler can be stamped or etched onto the surface of the tool in increments useful for the assembly of ductwork.

Scribe holes are also provided in a preferred embodiment in useful increments. The end of the tool can be tacked onto a surface, markers inserted in the scribe holes, and the tool rotated to create a circular mark to be cut out.

The tool also includes leveling bubbles on the tool. These leveling bubbles are useful to ensure that the ductwork is mounted in a level manner.

The tool is formed in a size and shape that allows it to be carried in a tool pouch and available for use when needed. The combination of features eliminate the need for carrying multiple tools on the job site.

These and other features will be evident from the ensuing detailed description of preferred embodiments and from the drawings.

### BRIEF DESCRIPTIONS OF THE DRAWINGS

FIG. 1 is a perspective illustration of a preferred embodiment of the present invention.

FIG. 2 is a top view of the embodiment of FIG. 1.

FIG. 3 is a side view of the embodiment of FIG. 1.

FIG. 4 is a bottom view of the embodiment of FIG. 1.

FIG. 5 is an illustration of a first step of using the embodiment of FIG. 1.

FIG. 6 is a second step of using the embodiment of FIG. 1.

FIG. 7 is a third step of using the embodiment of FIG. 1.

FIG. 8 is a perspective illustration of an alternative embodiment of the present invention.

FIG. 9 is a side view of the embodiment of FIG. 8.

FIGS. 10 and 11 are top views of the embodiment of FIG. 8.

FIG. 12 is an opposing side view of the embodiment of FIG. 8.

### DETAILED DESCRIPTION OF PREFERRED EMBODIMENTS

The present invention, in a preferred embodiment, provides a unique heating and cooling ductwork assembly tool. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

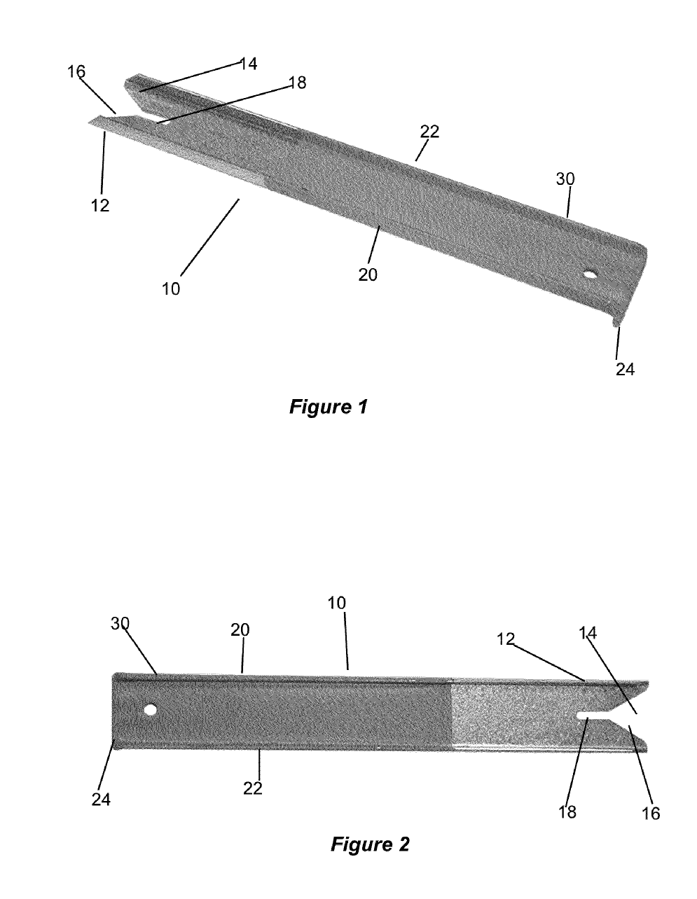

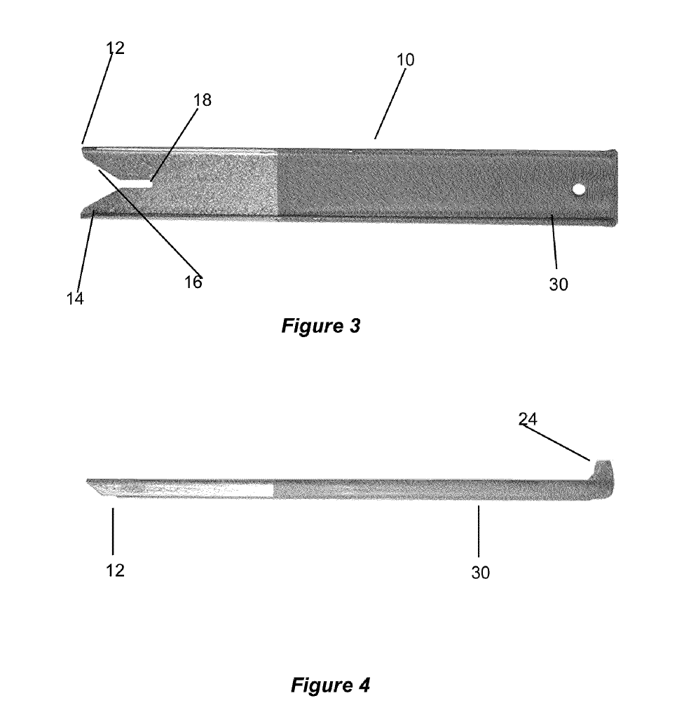

A preferred embodiment of the present invention is illustrated in FIGS. 1-4. The tool 10 of the preferred embodiment of the present invention utilizes a single piece of cut and formed sixteen gauge sheet metal that is nine and five-eights in length and one and three-eighths inch wide. It is to be expressly understood that other material choices could be used as well. For example, the tool could be formed from molded plastic, from cast metal or any other type of material. Also, other dimensional sizes may be included under the present invention.

The design of the tool 10 in this preferred embodiment utilizes a tapered Y-cut aperture 14 at one end 12 of the tool 10. This Y-cut serves as the channel that forces or pinches the sheet metal ductwork flanges together thereby eliminating the gap commonly found when assembling sections of ductwork. This force allows the ductwork to be joined with the drive cleat. The ductwork is pinched together simply by inserting the tool 10 on the ductwork gap and tapping it with one's hand or forcibly striking the tool with a hammer. The dimensions of the Y-cut channel are one and one-quarter inch wide at its uppermost width 16, tapered downward to a channel 18 of five-eighths inches in length and five-sixteenths inch in width. The overall length of the Y-cut channel is 1¼″ long. The design of the tapered Y-cut channel allows the invention to adapt to varying ductwork gap sizes of one inch or less.

The invention features two five-sixteenths inch ninety degree bends 20, 22 on each side of the tool subsequently forming a channel that serves as a “drive guide” that can be used to help install drive cleats during the ductwork assembly process. The invention also features a ninety degree three eighths inch bend 24 at the opposite end 18 forming a handle-end 30 that not only serves as a palm grip, but it creates the surface area to strike with one's hand or even a hammer. The handle 30 is six inches in length and is rubber-coated for a no-slip, comfortable grip of the tool.

The invention is not limited to the exact above dimensions and specifications and may be available in varying sizes of both the tool itself and the tapered Y-cut channel. The invention may also be produced, with or without the ninety degree bends on each side and may also be cut, stamped or formed with different gauges of metal. It also not limited to a rubber grip handle and may use dipped rubber or some form of coated vinyl as a handle grip material.

One particular trade in which the preferred embodiment of the present invention can be utilized is the installation and assembly of heating and air-conditioning ventilation systems. The ducts in these systems have metal assembly flanges on each end to enable a cleat to be positioned over the flanges to secure the ducts to one another.

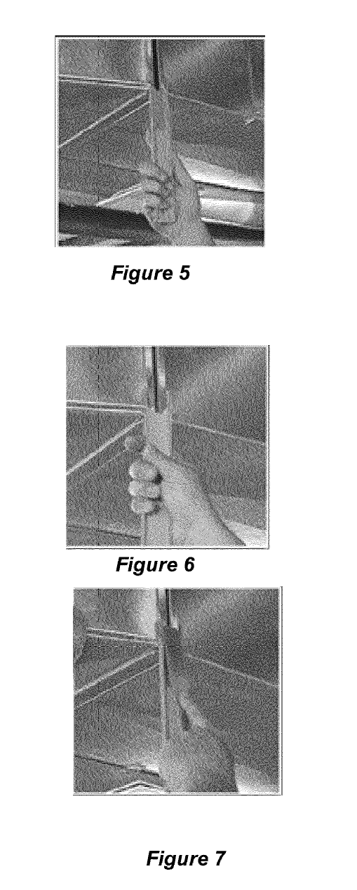

In use, as shown in FIGS. 5-7, the tool 10 is inserted in a gap between two pieces of adjoining ductwork. The sides of the upper width 16 of the Y shaped aperture 14 engage the cleats of the adjoining ductwork as shown in FIG. 5. The tool 10 is forced upward, by hand pressure on handle 30 as shown in FIG. 6 or by the force of a hammer on bend 24. As the tool 10 is forced upward, the cleats are driven along the angled sides 16 into slot 18. The slot 18 is approximately the size of the diameter of the cleats or slightly larger. This causes the two pieces of adjoining ductwork to engage together to form a single piece of continuous ductwork, as shown in FIG. 7.

Generally when duct work is hung overhead, a gap is created between two adjacent ducts necessitating drawing the ducts together in order that a cleat may be positioned over the flanges to secure the ducts together. The current invention solves this problem by providing a tool that performs the process of closing these varying gap sizes, at gap sizes of one and one-quarter inch wide or less, by pinching the flanges together between ducts in order to secure the ducts together. There are several advantages that this invention has over currently available tools.

The first advantage is its size. Many current duct stretchers or duct pullers, as they are known in the trade, are much larger than this invention. Some are nearly twenty one inch in length while others are bulky devices similar to a large pair of pliers or vise-type grips. The problem with these devices is that they are generally too large or too heavy to fit comfortably in a tool bag. If the tool is not in the HVAC installer's tool bag at the time it's needed, the installer must stop working and go get the tool and complete the task. This results in a non-efficient use of man-hours and higher costs. However, because this invention is less than 10 inches in overall length and weighs less than a pound, it's small enough so that it can be easily carried in the tool pouch at all times making it more practical than other current tools.

The second advantage this tool has is that it does not require large amounts of force to pull ducts together like some other rigid duct stretchers do. Rather, this invention uses a unique tapered Y-cut at the top-end of the tool that in effect serves as a self-guided channel. With only the push of a hand or the tap of a hammer this tapered Y-cut easily pinches or pulls the metal flanges together thereby minimizing troublesome gaps in ductwork. It does this with a lot less force by simply pinching the metal closer and closer together until it's traveled completely down the tapered channel and thus, pinched into a perfect position to install drive cleats. This perfect position requires little or no gap.

Plus, in most cases the tool can be left in place serving as a temporary clamp while the drive cleats are located and inserted. This is something other duct stretchers cannot do as they require constant leverage and pressure to pull or stretch gaps closed.

The third advantage this tool has over other current tools is the integrated drive-guide that makes installing drive cleats very simple. As drive cleats are what join ductwork together, having a convenient and easy way to fasten cleats can be advantageous. The unique ninety degree bends in both sides of this tool act as a drive guide so drive cleats can literally slide within the bends of the tool into a precise position. This precise positioning makes it easy to install cleats and thereby, easier to connect and assemble different sections of ductwork, whereas none of the other current tools utilize such a design. This tool is measured to work with standard drive cleats.

The fourth advantage is the narrow profile of the tool, which measures only about three-eighths of an inch. It is very adaptable to working in confined places especially when ductwork is run closely parallel to each other. Other tools, either because of their sizes or shapes, limit them from entering these tight spaces. However, because of the distinctive low-profile design of this invention, it is very capable of working within the confines of less than one half inch of clearance in tightly spaced ductwork making it an ideal tool as compared to other larger duct-puller or duct-stretcher devices.

Still another advantage when compared to other heating and cooling ductwork assembly tools is its modest cost. Because of this tool's one-piece design and simple shape, it can be very economical to produce and may have advantages in terms of market pricing and acceptance as compared to existing tools. All other current tools have multiple parts, many even with moving parts, leading to an increase in complexity that is not as competitive from a cost to manufacture basis. Current advances in sheet metal fabrication processes can easily produce this invention rapidly, in a scalable fashion, with high yields and low costs.

Tools are a necessary and essential asset of any tradesman. Having the proper and most efficient tool for a given task can result in an enormous cumulative reduction in man-hours and material, and thus, costs.

The advantages it has over current conventional tools include its compact size, making it ideal to carry in a tool bag and immediately accessible when needed; its ease-of-use, proven by its unique tapered Y-cut channel that easily pinches ductwork together; and it's low cost one-piece design, making it not only practical from a user's perspective, but may also make it a very practical and reasonable solution from a manufacturing and business standpoint.

### Alternative Preferred Embodiment

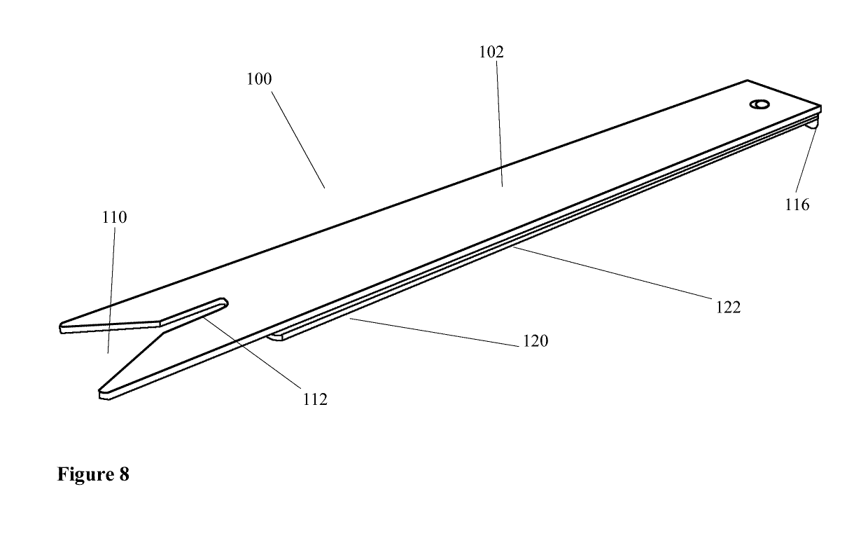

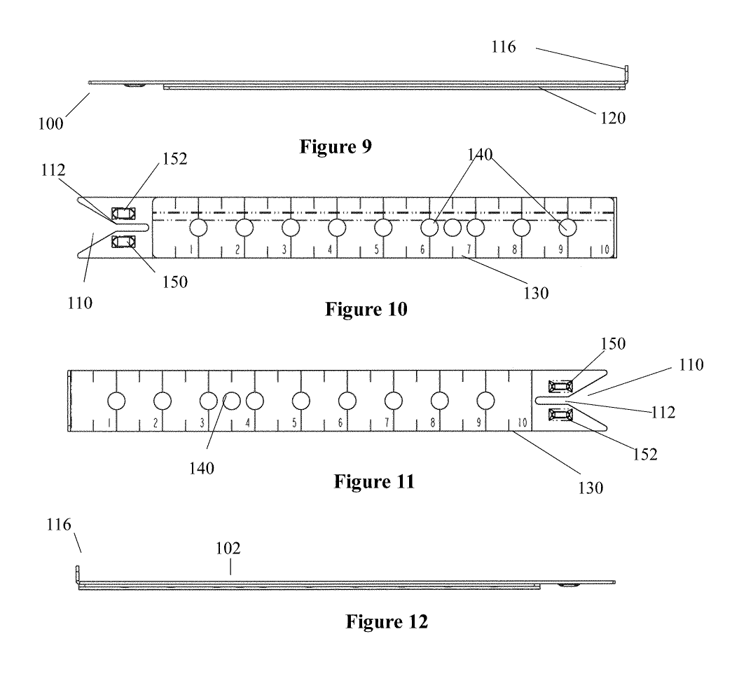

An alternative preferred embodiment is illustrated in FIGS. 8-11. The tool 100 of this preferred embodiment includes a substantially elongated rectangular member 102. The tool also includes a substantially Y shaped aperture 110 on one end of the member 102. This aperture 110 includes a slot 112 extending into the aperture 110. The size of the aperture 110 and slot 112 are selected to be used on an appropriate size of sheet metal. For example, for ductwork gaps of one inch or less, the aperture 110 may be one and one-quarter inch wide at the uppermost width and tapering down to the slot 112 having a width of about five-sixteenths inch. The length of the aperture 110 and slot 112 is about one and one-quarter inch. Other sizes can be used as well.

The tool 100 includes a downward bend 116 at the other end of the tool member 102. The bend 116 forms a handle for the use of the tool 100.

The tool 100 of this embodiment also includes an extended jaw 120 formed along the length of the member 102. The jaw 120 has a slot 122 extending into the jaw. The slot can be any desired width and depth. In this particular embodiment, the slot is about three-eighths inch wide and deep. The jaw 120 allows a fold to be created in the duct sheet metal for assembly purposes. Also, the jaw 120 may be used to create a seam with two sheet metal ends.

The tool 100 also includes a measurement ruler 130 formed on the upper surface of the member 102. In this particular embodiment, the ruler is ten inches long with marks stamped or etched in one-half inch increments. The ruler may also include increments in metric units of measure. The ruler can be used in the assembly and mounting of the duct work as well as being used for other measurements.

Another feature of this preferred embodiment includes scribe holes 140. The scribe holes 140 are formed in the member 102 in standard increments such as at one inch increments along the ruler. The scribe holes 140 can also be formed at increments that standard in the industry. The scribe holes have a diameter that will allow a pencil, scribe tool or other marker to be inserted therein. The tool 100 can be tacked or held on one end and the marker inserted in the appropriate scribe hole 140. The tool can then be rotated about the tacked end to create a circular template in the desired diameter. This template can then be cut-out.

The tool 100 also may include level bubbles 150, 152 in the member 102. The level bubbles 150, 152 are useful to ensure that the duct is being mounted in a level manner.

The above descriptions of exemplary embodiments are not meant to limit the scope of the claimed inventions but are provided only for descriptive purposes.

What is claimed is:

1. A tool for assembly of heating and cooling duct work, said tool comprising:
a tool body of substantially flat configuration;
a tapered inverted aperture at one end of said tool for engaging cleats of adjoining ductwork; and
a handle portion on the other end of said tool.

2. The tool of claim 1 wherein said tool further includes:
a slot extending inward from said tapered inverted aperture for forcing the cleats of the adjoining ductwork into a continuous seam.

3. The tool of claim 1 wherein said tool further includes:
a jaw formed along the length of said tool body for engaging sheet metal edges to form a seam.

4. The tool of claim 1 wherein said tool further includes:
a jaw formed along the length of said tool body for engaging sheet metal edges to form a fold on the sheet metal edge.

5. The tool of claim 1 wherein said tool further includes:
measurement marks formed on a surface of said tool body.

6. The tool of claim 1 wherein said tool further includes:
scribe holes formed in increments along said tool body.

7. The tool of claim 1 wherein said tool further includes:
leveling bubbles mounted on said tool body.

8. The tool of claim 1 wherein said tool further includes:
a slot extending inward from said tapered inverted aperture for forcing the cleats of the adjoining ductwork into a continuous seam; and
a jaw formed along the length of said tool body for engaging sheet metal edges to form a seam and to create a fold.

9. The tool of claim 1 wherein said tool further includes:
a jaw formed along the length of said tool body for engaging sheet metal edges to form a fold on the sheet metal edge and to form a seam.

10. The tool of claim 1 wherein said tool further includes:
measurement marks formed on a surface of said tool body; and
scribe holes formed in increments along said tool body.

11. The tool of claim 1 wherein said tool further includes:
measurement marks formed on a surface of said tool body;
scribe holes formed in increments along said tool body; and
leveling bubbles mounted on said tool body.

12. A tool for assembly of heating and cooling duct work, said tool comprising:
a tool body of substantially flat configuration;
a tapered inverted aperture at one end of said tool with a slot extending inward from said aperture for engaging cleats of adjoining ductwork;
a handle portion on the other end of said tool; and
a jaw formed along the length of said tool body for engaging sheet metal edges to form a fold on the sheet metal edge and to form a seam.

13. The tool of claim 12 wherein said tool further includes:
measurement marks formed on a surface of said tool body.

14. The tool of claim 12 wherein said tool further includes:
scribe holes formed in increments along said tool body.

15. The tool of claim 12 wherein said tool further includes:
leveling bubbles mounted on said tool body.

16. The tool of claim 1 wherein said tool further includes:
measurement marks formed on a surface of said tool body; and
scribe holes formed in increments along said tool body.

17. The tool of claim 1 wherein said tool further includes:
measurement marks formed on a surface of said tool body;
scribe holes formed in increments along said tool body; and
leveling bubbles mounted on said tool body.
